(19) United States
(12) Patent Application Publication
(10) Pub. No.: US 2010/0107706 A1
(43) Pub. Date: May 6, 2010

(54) DOOR LOCKS

(76) Inventor: Jung-Ho Oh, Goyang city (KR)

Correspondence Address: CHRISTOPHER PAUL MITCHELL, 888 16TH ST., NW, SUITE 800, WASHINGTON, DC, 20006, US

(21) Appl. No.: 12/529,805

(22) PCT Filed: Mar. 5, 2008
(86) PCT No.: PCT/KR2008/001247

§ 371 Date: Sep. 3, 2009

(30) Foreign Application Priority Data
Mar. 6, 2007 (KR) 10-2007-0021760
Apr. 24, 2007 (KR) 10-2007-0039812
Apr. 26, 2007 (KR) 10-2007-0040709
May 21, 2007 (KR) 10-2007-0049231
Mar. 4, 2008 (KR) 10-2008-0019929

(51) Int. Cl. E05B 65/00; E05B 15/14; E05B 29/00

(52) U.S. Cl. 70/91; 70/490; 70/377

(57) ABSTRACT

This invention has the following structures and features: unlocks only when pressing inner keys that correspond to the upper section or inclines of the key; deadlock structure which acts as a non-powered prevention method of coercive rotations; reducing the probability of equal key presence without altering the key size by inserting two or more inner keys for simultaneous pressurization and alignment. Due to the fact that digital door locks are prone to static electricity, high voltage, magnetic fields and surges, this invention can be utilized as a safe means of analog keys; in case of car door locks, this invention can be utilized as emergency keys. In addition, coercive rotation preventing features such as gears, twists and torque shares will prove to be very useful for all type of door locks such as deadlocks, cylinder or lever-type knobs as they provide three to fivefold stronger safety.

### TECHNICAL FIELD

This invention is in regards to door locks and a system with functions that prevents coercive unlocking trough non-electric powered blocking of rotation and reduces possibilities of equal key presence.

To elaborate in detail, this invention features three to fivefold safety functions such as twisted shapes and bolted deadlocks; also, in this plug structure one or more inner keys can be added to the conventional plug structure so that unlocking is only possible when the upper surface (head) of the key presses the designated upper surface of the inner key, and with this inner key structure the probability of equal key presence is reduced even when the key size is unchanged.

Therefore, this invention is for utilization in simple structures such as cylinder door locks, lever-type door locks, analog keys of digital door locks, and for utilization on emergency analog keys for car door locks with no-key structures; analog keys are essential as emergency keys for digital door locks as they show fragility on static electricity, magnetic fields, surges, and heat in case of fire.

### BACKGROUND ART

Existing door locks consist of a cylinder, a plug which is equipped inside the cylinder, a number of pins inserted in the plug, and a key which aligns the pins. It is important that the pins do not be easily aligned with a device other than the key, but at the same time durable to coercive attempts for rotation. However, due to a simple structure, unlocking is possible with plain implements or a universal key, not to mention problems with coercive rotation.

Such problems are related to virtually all analog type door locks, including cylinder/lever type door handle locks, deadlocks, analog emergency keys for digital door locks, and automobile door locks.

### DISCLOSURE OF INVENTION

Objectives of this invention is to develop a structure which unlocks only when the upper section of the key presses a corresponding inner key; a bolted deadlock structure which prevents coercive rotation without specific electric power sources; develop an interlocked rotation-preventing structure which blocks rotation without specific electric power sources; develop an equal sized-key with reduced probability of an equal key; develop a cylinder, plug and pin structure which can be implemented in simple cylinder lever type door locks as well as analog key & lock system for costly multifunctional digital door locks and car door locks suitable for no-key structures with highly complicated structures for unlock prevention; and to develop door locks with three to fivefold safety locking abilities with a torque share section that detaches in case of forced destruction.

This invention is able to realize the abovementioned objectives with configuration of cylinders, plugs, pins (top & bottom pins) and additional configuration of rotation-preventing methods as well as methods to reduce equal key presence probabilities.

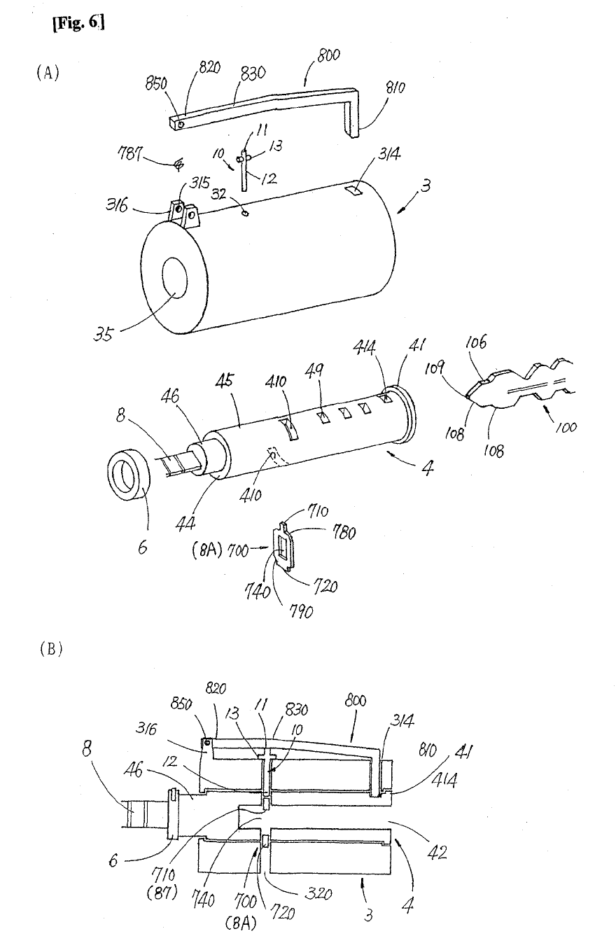

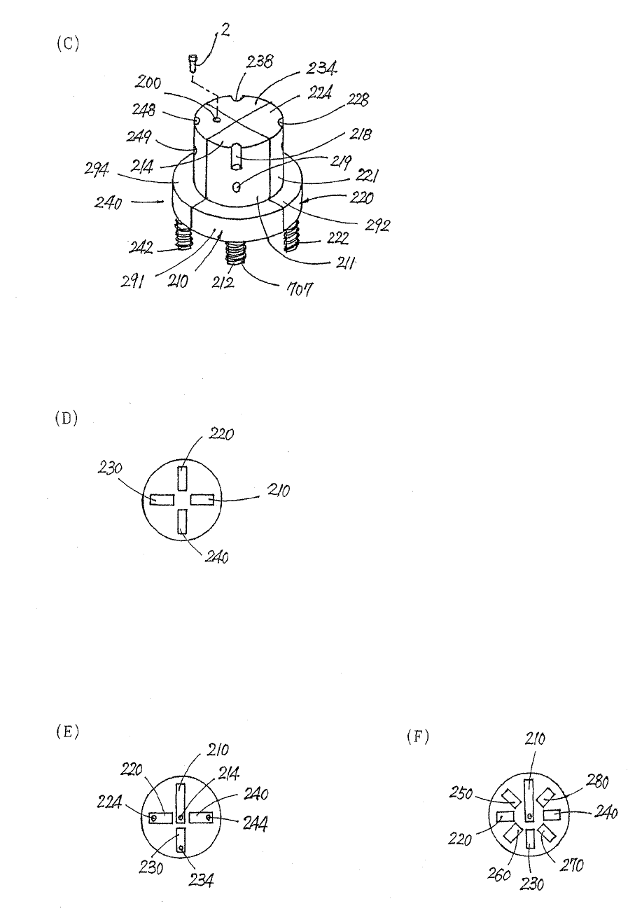

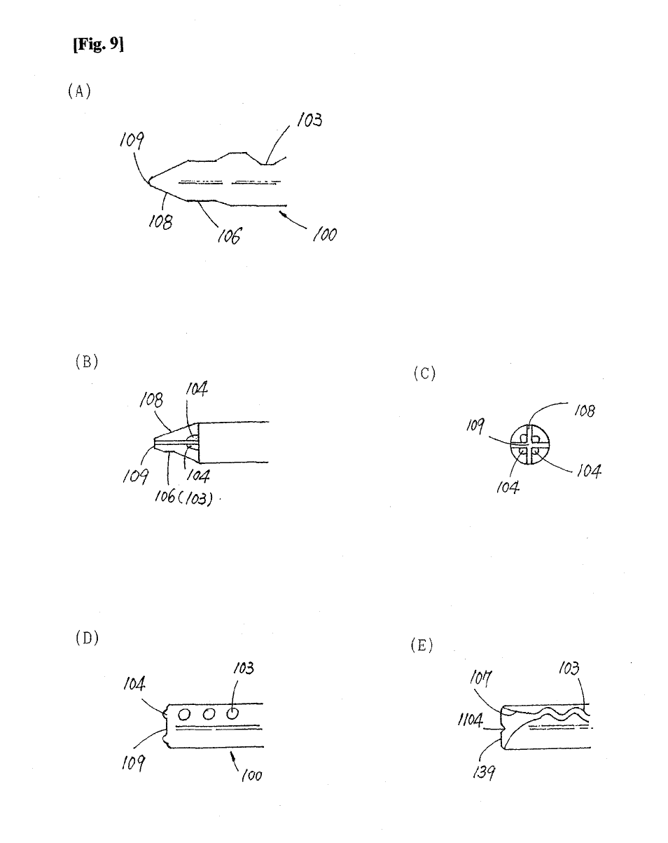

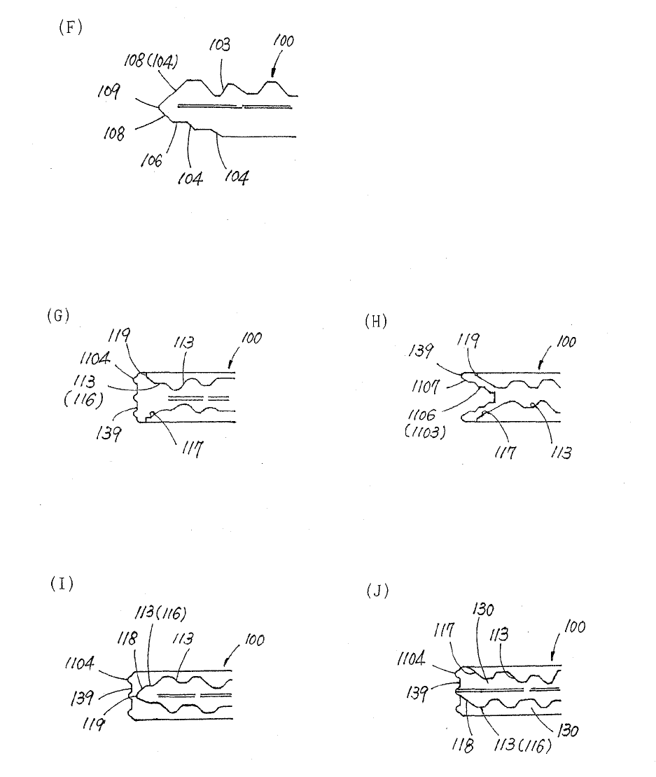

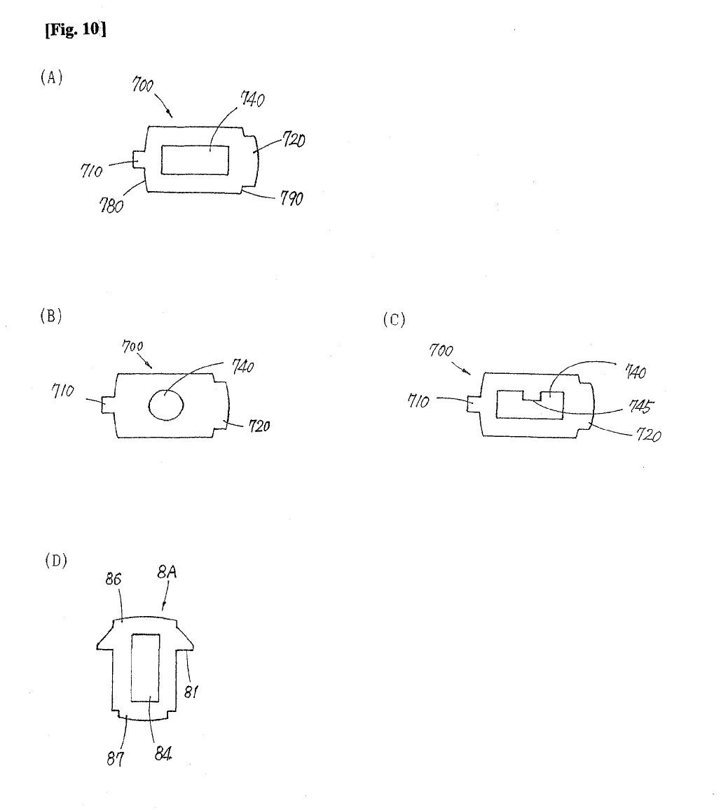

Therefore, Configuration 1 of this invention is one from ordinary door locks which has a rotating plug (4) with a keyhole, and (42) a turning axis (46) at the bottom; numerous pins (92, 91) are inserted through the cylinder (3) and plug (4). When a key (100) is inserted into the abovementioned keyhole (42), the waving curve or groove (103) of the key aligns the edges of the upper & lower pins (92, 91) with the inner surface cylinder (3) and the plug (4); under such a condition will the plug (4) and the turning axis (46) rotate (right/left) for locking and unlocking. In the case of this ordinary door lock configuration, two or more lock plate holes (410) will be made on the bottom of the plug with an extended keyhole (42) to form a plug (4) that corresponds to the lock plate holes. The cylinder will have holes (32) corresponding to the conventional lower pins (91) and a number of holes (320) corresponding to the number of lock plates, to which the lower section of the lock plate (720) is inserted. The lock plate (700; FIG. 10A) holds hitches (780, 790) and a center hole (740) for inserting bullet-shaped inclines or a flat key. The key (100) is to be either a flat key with a front surface (109) and incline (108) or a bullet-shaped key, or one with flat surfaces (106) in between planes (108). The lock plate is to be inserted into the lock plate hole (410) and the plug (4) is assembled with the cylinder (3); in the cylinder pin holes (32) the lower pins (91) and springs (9) will be inserted to press the upper section of the lock plates (710) so that the lower section (720) is inserted as far as the hitch in the hole (320). When the key is inserted into this structure, the incline (108) and each lock plate center holes (740) will have each lock plates to push the lower pins (91), thus each lower section (720) is pulled out of the holes (320) in the flat surface (106); this means that the outer surface of the plug is exactly the same as the alignment of the pins, thus enabling the key to rotate or rotate after a push. Therefore, the abovementioned lock plates can be a method of preventing coercive rotation, and an implementation (refer to lock plates (700; FIG. 6) and keys (100; FIG. 9A)) of technical objectives of this invention. Here, lock plates (700) could be substituted with upper pins (92).

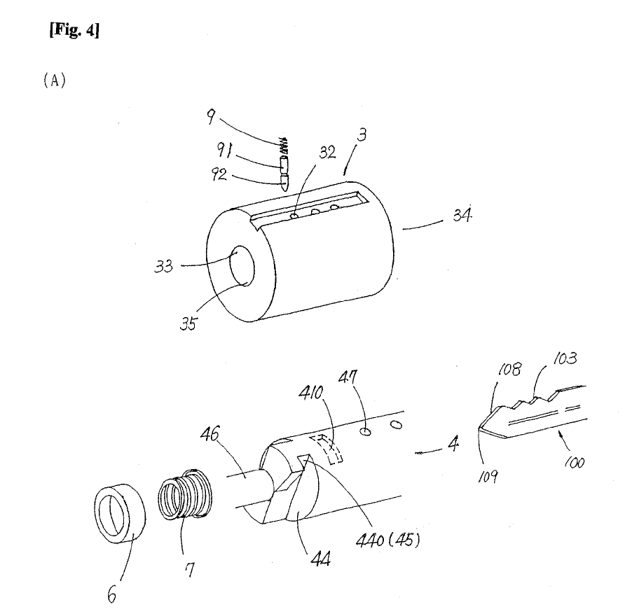

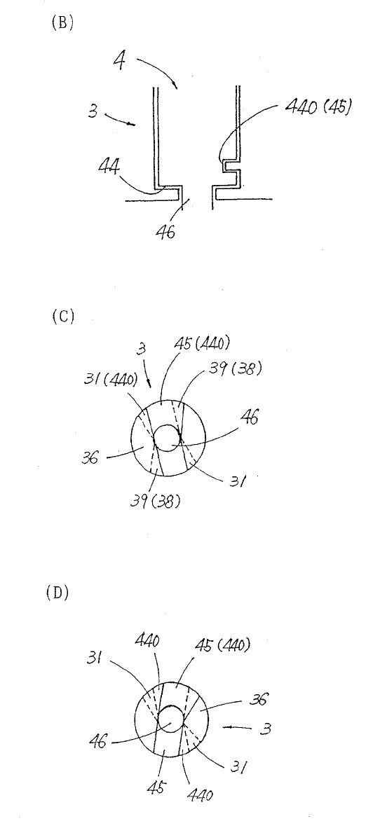

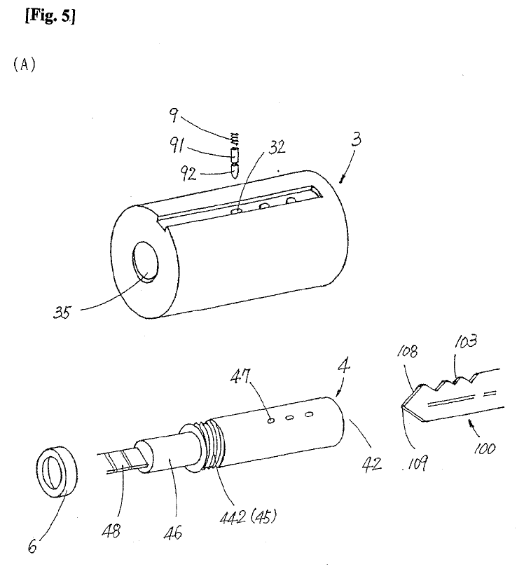

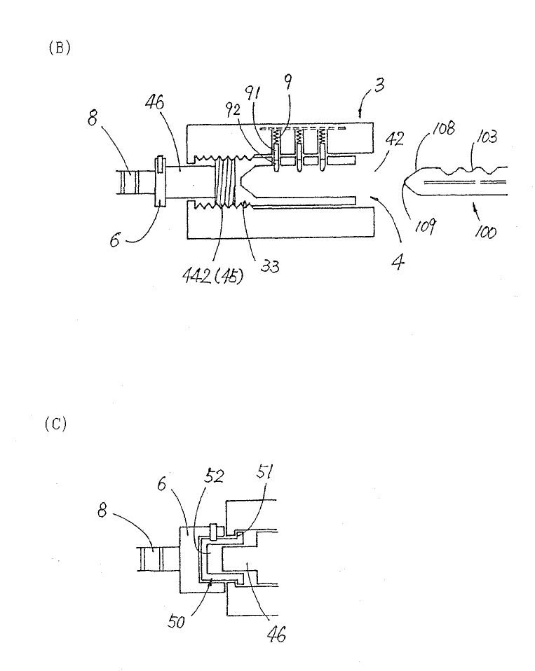

In Configuration 2 (FIG. 4), lock plates (700) have protrusions at bottom side (735; FIG. 10G) and in the lower part of the abovementioned lock plates is a protruded shape (45) with a staircase surface (440). In the inside of the lower section of the cylinder, there is a groove (38) with an interval (39) holding a hitch (31) that is to have the staircase surface (440) of the abovementioned protrusion locked into. When necessary, springs (7) can be inserted to the exact position where the plug (4) is rotated as far as the interval to evade the groove (38) so that the spring can pull or push the plug. The stopper/hitch (6) is to be fixed. When the key is inserted, the upper part of the lock plates will rise, unraveling the protrusion at bottom side (735); rotation is enable only to the extent of the intervals, and the staircase surface will lock onto the hitch (31). When the key is pulled, the protrusion at bottom side (735) of the lock plates will be locked onto the intervals, thus preventing any rotation to a higher extent. In other words, the abovementioned staircase surface (440) is added to Configuration 1 to form even a stronger method of preventing coercive rotation. Here, prevention of coercive rotation can be implemented through the following: the staircase protrusion can be twisted; a screw bolt (442; FIG. 5A) can be used; a nut can be locked/unlocked to the above bolt in case of advancing or pulling movement (FIG. 5B) within the cylinder. Here, an absorption axle can be used to keep the axle from moving forward/backwards in the plug (FIG. 5C). Also, a torque share section (490) can be added to the lower border surface of the plug, staircase protrusion, twisted protrusion, and the screwed protrusion; it is to be separated in case of coercive rotation, and even when damaged, the spring (7) will keep the protrusions from separation. High-intensity pins can be inserted in the protrusions when necessary to implement technical objectives of this invention.

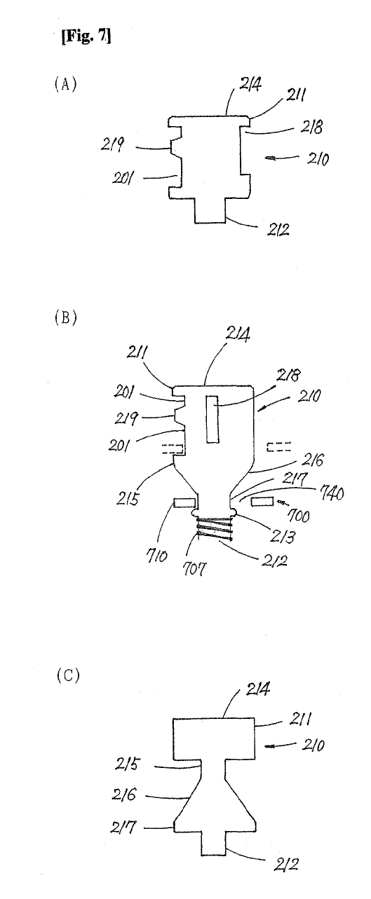

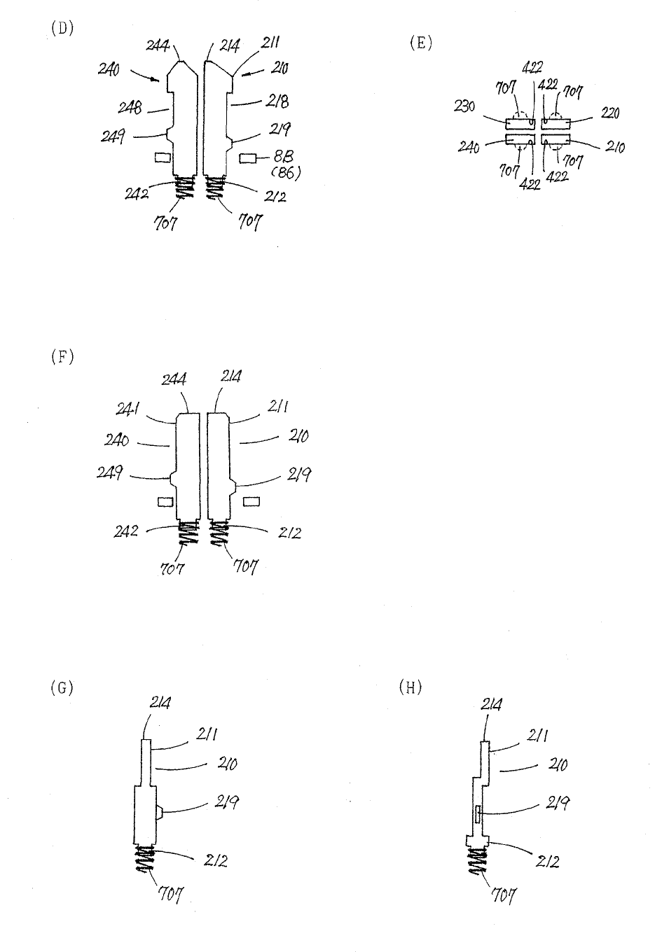

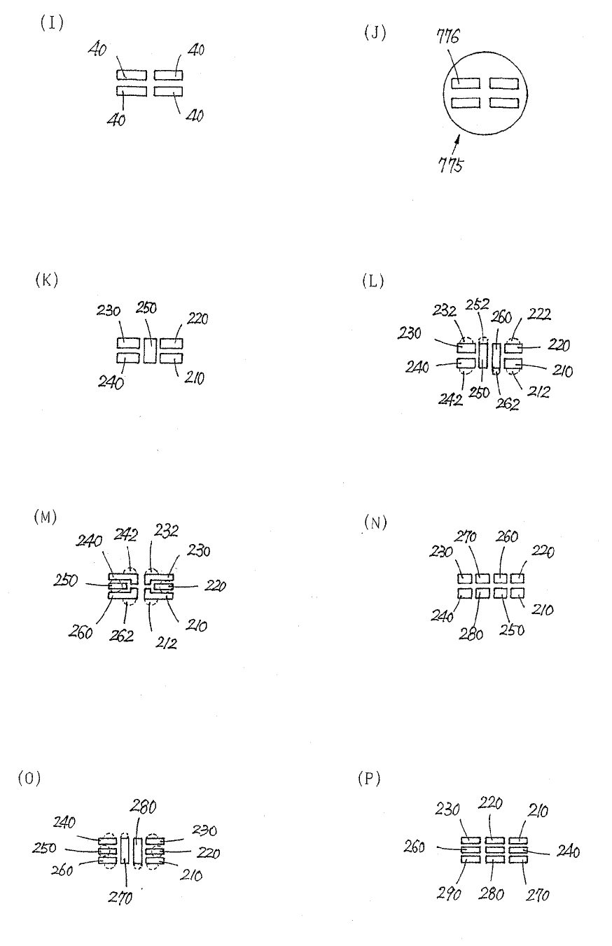

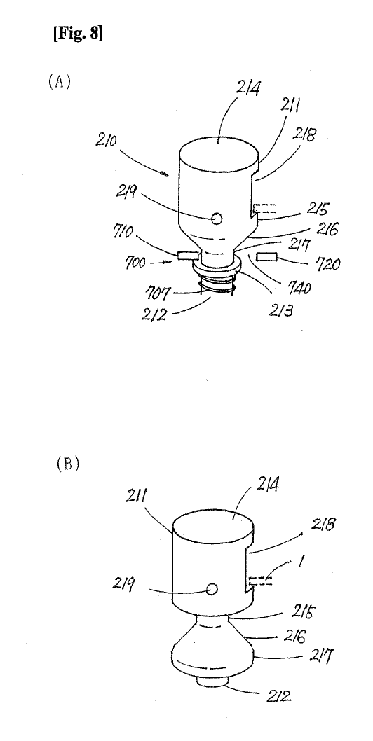

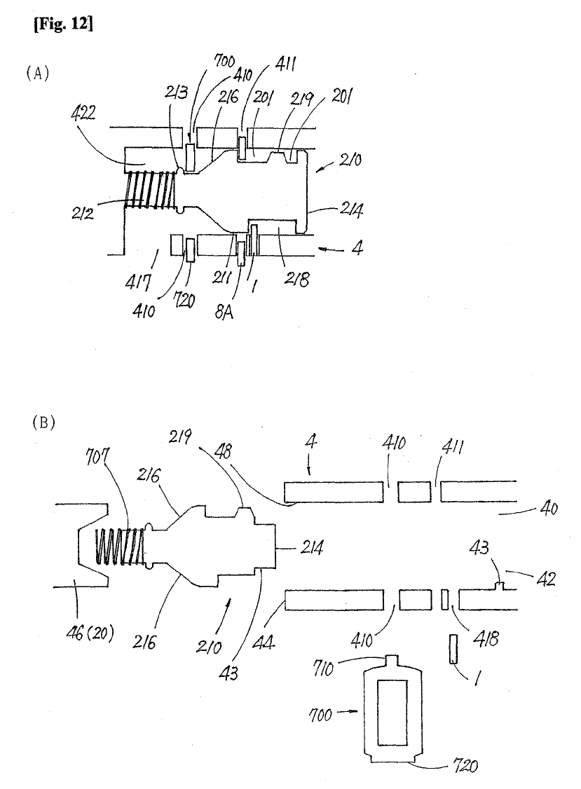

Configuration 3 has on the lower section of the plug an extended keyhole (422) into which one or more inner keys are separately inserted. The plug (4) has on its side pin holes (418, 428, etc) upper pin holes (47), and spring holes (417, 427, etc). As shown in FIG. 7D, geometrical top surface (214, 224, etc), the upper section (211, 221, etc) or the side can have horizontal grooves (218, 228, etc) and waving curves or grooves (219, 229, etc) underneath them, and the lower section (212, 222, etc) even beneath to form inner keys (210, 220, etc). The cylinder will have a lower pin hole (32) on the location of the upper pin hole (47) of the plug; abovementioned lower section (212, 222, etc) of the inner key forms an extended keyhole (422; FIG. 8D). Springs (707) are inserted into each lower section (212, 222, etc) and pins (1) are pierced through pin holes (418, 428, etc); they are fixed as inserted in the horizontal grooves (218, 228. etc) to form a single plug (FIG. 12A). Then the plug (4) is inserted into the cylinder (3) and assembled by pressing them together with upper and lower pins (92, 91) and a small spring (9) pushed into each pin hole (32, 47). When the key (100; FIG. 9B, 9C) is inserted, the geometrical shape of the key front or incline (108) or even the geometrical shape of the groove (104) of the space between inclines can press the waving curve or grooves (219, 229, etc) of the inner key to align upper and lower pins and thus allowing the key to turn. The axle (46), which is a single attached piece with the plug (4), is separated so as to form a plug and axle (20; 46); the axle hole and inner key holes (422) are at a single space (FIG. 12B). In the upper section of the inner key, horizontal grooves are rid of (FIG. 7F) and the lower section (212, 222, etc) can be changed into protrusions (FIG. 7H); the inner key are inserted into each inner key holes. Springs (707) are inserted into each lower section and a spring stopper plate (775; FIG. 7J) is used to fix the inner key on the bottom of the plug. The plug has the axle inserted and fixed into the axle hole (48), and the hole for upper sections of inner keys (40; 422) are located on the position of the incline (108) and geometrical grooves (104; FIG. 9B, 9C) of the key. The upper section of the inner key (211, 221, etc) forms a [symbol] shape, forming an angle with the upper pin holes (47) of the plug (FIG. 7H). As for the plug, the inner key is inserted into the inner key hole (776) of the insertion plate (775), on the top of each waving curve of groove (219, 229, etc). The key has configurations (FIG. 9B, 9C) which have geometrical grooves (104) between inclines (108); this key structure and inner key designs in FIG. 8A, 8B, 8C, 8E, 8F are included in this invention. Also, a structure formed through combination of Configurations 2 and 3 are also included in this invention. In this structure, the inner key can be a method to reduce the probability of equal keys, thus implementing a technical objective of this invention. Configuration 1 is the simplest configuration and Configuration 3 is the high-functionality structure. Configuration 2 is the medium of the two configurations, and can be utilized as deadlock keys and emergency analog keys for digital door locks.

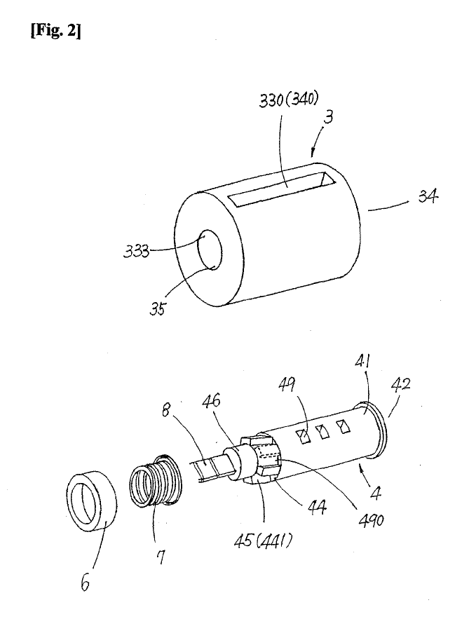

Configuration 4 is Door locks that turns and unlocks when the key (100) is inserted into the keyhole (42) and plate pins (8A) inserted into the side holes (49) of the plug are aligned at grooves or holes (330, 340). Compositions are the cylinder (3), plug, and a stopper/hitch (6) that is tightened to the axle (46). There is a protruded shape (45) on either the upper section (41) or the bottom of the plug (FIG. 2) and the axle (46) is in one piece with the plug. As for the cylinder, it holds an engraved groove (333) which is to fit with the twisted protrusion. A spring (7) can be inserted into the axle (46) push or pull the plug. A stopper/hitch (6) for fixation is located on the position where the twisted protrusion is unraveled from the engraved groove. The twisted shape or twisted gear (441) protrusion refers to a geometrical protrusion such as rectangle, square, pentagon, and eclipse shapes twisted to a certain extent; also, an engraved groove can be made on the cylinder to fit this twisted protrusion. A torque share section (490) can be added between the twist and bottom of the plug, and here the twisted protrusion works as a method to prevent coercive rotation or turning, thus implementing the technical objectives of this invention. Such a structure is adequate for cylinder type and lever type door handle locks.

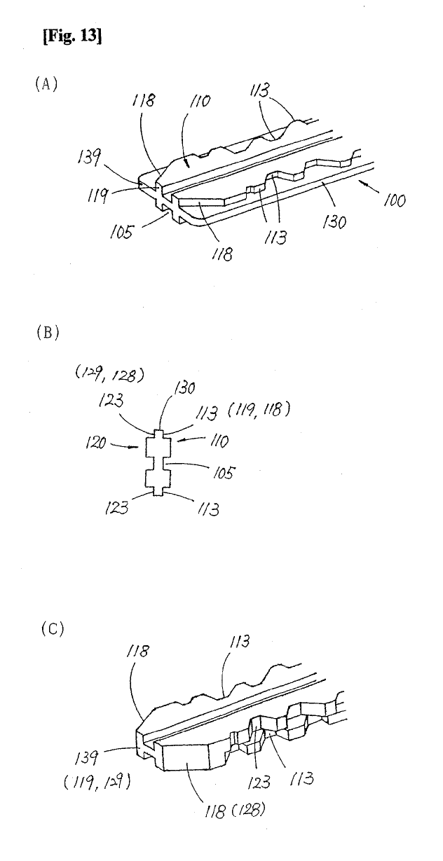

In Configuration 5, plate pins and the key are different from Configuration 1. This configuration especially has plate pins adequate for car door locks; when the key is a flat key (FIG. 9A), plate pins (700) function as lock plates (FIG. 10D), when the key is an engraved key (FIG. 9H, 14A), plate pins (700) function as lock plates (FIG. 10E), and when the key is an embossed key (FIG. 91, 13), plate pins function as lock plates (FIG. 10F). When the key is an embossed/engraved key (FIG. 9J, 14), embossed/engraved plate pins can be used as lock plates. Also, plate pins can be separated plate pins (FIG. 13E, 13F), separated plate pins (14B), and separated plate pins (15A, 15B, 15C), thus reducing the probability of equal keys. Also, usage of the upper section and incline of various keys and direct/indirect alignment of plate pins (separate plate pins) also provide a solution for the technical objective of this invention.

Configuration 6 is similar to Configuration 2 but has additional twisted gear or twisted protrusions; this method of preventing coercive rotation is even stronger than in Configuration 5.

Configuration 7, unlike Configuration 3 which has an inner key added to the conventional deadlock door lock, has an additional inner key adequate for car door locks as a means of reducing equal key probabilities. In detail, the door lock consists of a cylinder (3), a plug (4) installed into the cylinder, and a stopper/hitch (6) that is tightened to the axle (46) that sticks out of the cylinder. The key (100) is inserted into the plug keyhole (42), thus aligning numerous plate pins (8A) or pairs of separate plate pins (8B, 8C) at the horizontal groove or hole (330, 340) of the cylinder. In this door lock structure, one or more inner keys (FIG. 7A, 7D) are placed to protrude from the bottom of the keyhole as shown in FIG. 12A, and they are used as a means of reducing equal key probabilities, as they each have to be pressed by the front section and inclines (refer to Configuration 9) in order to unlock. Also, as shown in FIG. 12B, one or more inner keys (FIG. 7F, 7G) are placed to protrude from the bottom of the keyhole, thus also working as a means of reducing equal key probability. As for the plug, there are a number of inner keys (210, 220, . . . , 290, etc; FIG. 7K, 7L, 7M, 7N, 7O, 7P) and the insertion hole (40) of the plug corresponds exactly to each inner key in terms of location, number and surfaces. The plug also has insertion holes (49) for plate pins, in some cases separated, which are pressed by the waving groove of the inner keys. A spring stopper plate (775; FIG. 7J) holds the separated plate pins (single-layer) and the rest of the inner keys, passing through the inner key insertion hole (776) at the abovementioned spring stopper plate, is inserted into the insertion hole (40) of the plug, pressed and held by the spring stopper plate (multiple-layer); an axle (46) is inserted through the axle hole (48) to hold the plug together. Therefore, this configuration uses a number of inner keys to minimize the probability of equal keys, thus implementing technical objectives of this invention.

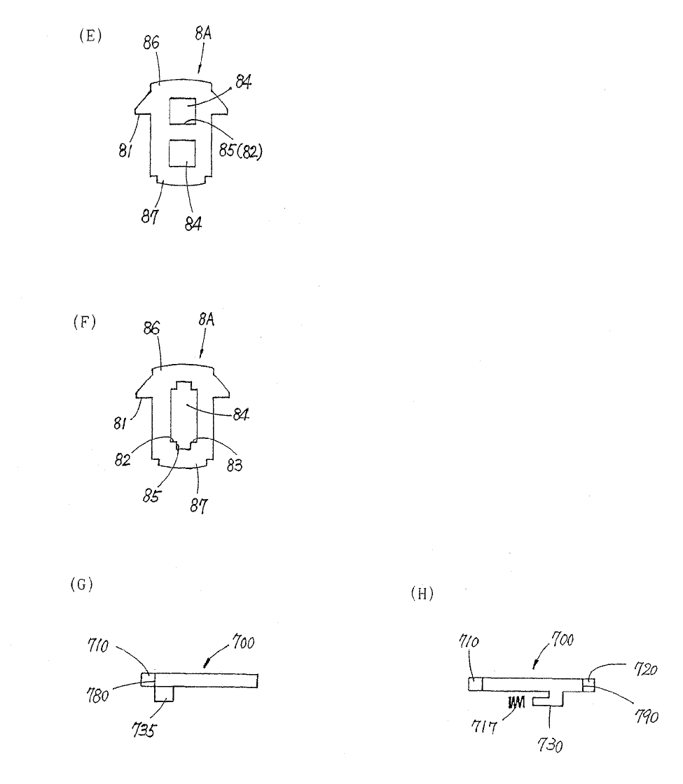

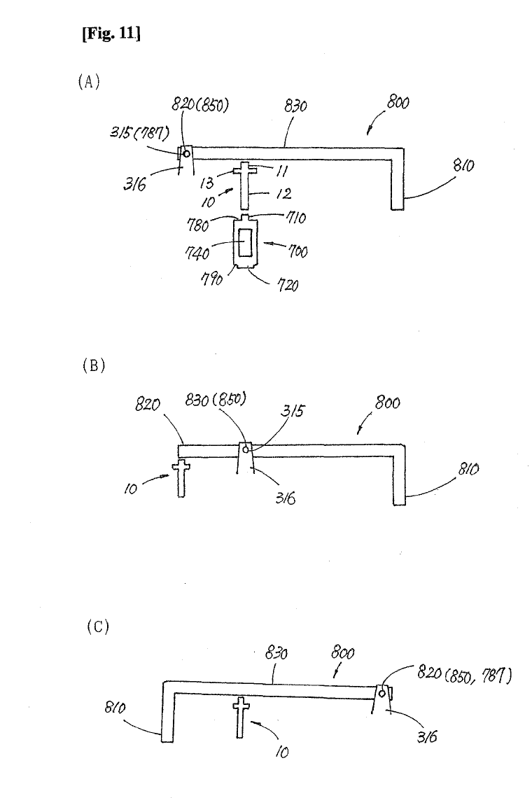

Configuration 8 (FIG. 6, 11A) has a stopper/groove (414) on the upper section (41), protruded shape (45) or the axle (46) of the plug. The cylinder (3) has a hole (314) at a corresponding position as the stopper/groove (414) of the plug. There is also a pin hole (32) for inserting the lower section (12) of the pin (10) into the groove (340) where lower protrusions (87) of plate pins are hooked. In the case when there is a stopper/groove at the upper section (41) of the plug, there should be a protrusion (316) with pin holes (315) at the top. When there is a stopper on the protrusion or axle (FIG. 11C), the cylinder should have a protrusion (316) in between pin holes (32) and front of the plug. There is a lever (800) which consists of a shaped upper section (810) and lower section (820) with pin holes (850). The pin consisting of an upper section (11), stopper ring (13) and the lower section (12) is inserted into the pin hole (32) to meet the lower protrusion (87) of the plate pin. The upper section (810) of the lever is inserted into the hole (314) all the way to the stopper/groove (414) and the center section (830) of the lever, while pressing the upper section (11) of the pin, combining the pin hole of the stopper and pin hole (850) at the lower section (820) and the spring (787). In such a structure, when the key is inserted, inclines (117, 127 or 108) pull the lower protrusions (87) of the plate pins out of the groove or hole (330), thus aligning the plate pins with the outer border surface of the plug. At the same time, the lower protrusions (87) of the plate pins push the lower section (12) of the pin to make the upper section (11) of the pin lift the center section (830), thus pulling the upper section (810) of the lever out from the stopper/groove (414). This acts as a prevention device for rotation; the lever (800) is a bolted deadlock which can prevent coercive rotation without specific electric power sources, thus implementing a technical objective of this invention.

Since coercive rotation preventing methods of Configurations 1, 2, 5, 6, 8 does not have much use as a means to minimize equal key probabilities, Configuration 9 is a configuration where inner keys of Configurations 3 and 7 are increased to reduce equal key probabilities. In order to increase this inner key combination, the key holds one or more geometrical grooves (104, 1104) in between inclines (108), the front surface (109, 119, 129, 139), or the vertical side of the front surface (139; FIG. 9B, 9C, 9E, 9G, 9I, 9J). Another combination is to make one or more flat surfaces (106, 116, 126, 1106) or geometrical waving curve or grooves (103, 113, 123, 1103) on the inclines (107, 108, 117, 118, 127, 128, 1107) of a normal key or M-type key (FIG. 9H). For details refer to FIGS. 9G, 9I and 9J. Therefore, the number of plate pins or separated plate pins on the side of the plug is increased, which allows selective utilization of geometrical grooves (104, 1104) to press the inner keys, front surface (109, 119, 129) of the key, flat surfaces (106, 116, 126), waving sides, and waving curves or grooves (103, 113, 123, 1103); this maximizes the number of pins, reducing the probability of equal keys even more to implement a technical objectives of this invention

In sum, the key from this invention can be added to Configurations 1-8 to maximize prevention of coercive rotation and reduction of equal key probabilities. Such a structure can be applied as follows: Configurations 1-3 on deadlocks/digital door locks, Configuration 4 on cylinder type and lever type door handle locks, and Configurations 5-9 on car door locks.

This invention has a structure of one or more inner keys added to a conventional door lock; staircase surfaces, screws, twisted gears, twisted shapes, bolted deadlock levers, and lock plates for preventing coercive rotation; and an inner key structure that allows reduction of equal key probabilities while the key size remains the same. As this invention holds three to fivefold safety functions, anyone other than the key holder cannot open this invented door lock even with equipments or universal keys. Non-electric powered deadlocks and levers make it difficult to coercively turn the door lock; even in case of coercive turning, only the twisted part is separated from the torque share section. High-intensity pins make it difficult even for a drill to destruct this door lock. The invention seems very useful for cylinder-type door locks, deadlocks, analog emergency keys of digital door locks, and car door locks.

### BRIEF DESCRIPTION OF FIG.

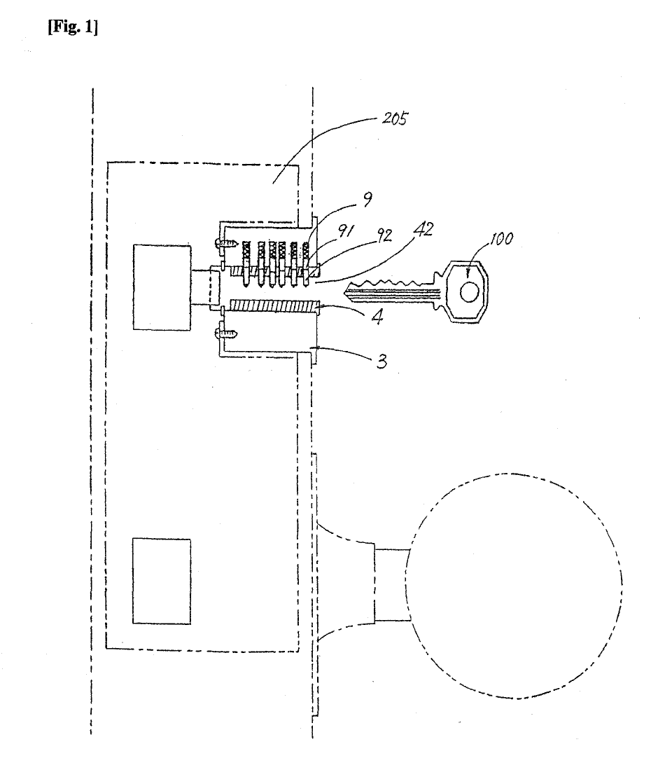

FIG. 1 is a cross-section fig. of conventional door locks

FIG. 2 is a three-dimensional fig. of one disassembled example of the invention

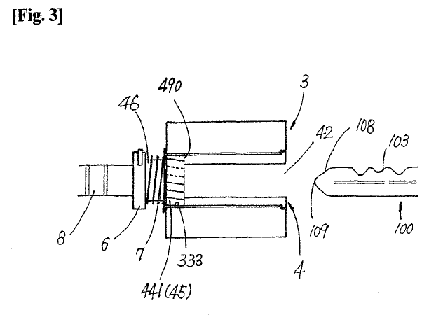

FIG. 3 is a cross-section fig. of an assembled example of FIG. 2

FIG. 4A is another three-dimensional fig. of one disassembled example of the invention

FIG. 4B is a partial cross-section fig. of FIG. 4A

FIG. 4C is an assembled plane fig. of FIG. 4B

FIG. 4D is a rotated cross-section fig. of FIG. 4C

FIG. 5A is a three-dimensional fig. of one disassembled example of the invention

FIG. 5B is an assembled cross-section fig. of FIG. 5A

FIG. 5C is a cross-section fig. of an absorption axle

FIG. 6A is another three-dimensional fig. of one disassembled example of the invention

FIG. 6B is an assembled cross-section fig. of FIG. 6A

FIG. 7A is an illustrative fig. of inner keys inserted into keyholes of this invention

FIG. 7B is a front view of another example of FIG. 7A

FIG. 7C is a front view of another example of FIG. 7B

FIG. 7D is an illustrative fig. of multiple inner keys inserted into keyholes of this invention

FIG. 7E is an illustrative fig. of an inner key inserted into an extended keyhole of FIG. 7D

FIG. 7F is an illustrative fig. of inner keys inserted into the bottom of the plug

FIG. 7G is an illustrative fig. of inner keys in another example of FIG. 7F

FIG. 7H is an illustrative fig. of inner keys in another example of FIG. 7F

FIG. 7I is an illustrative fig. of the hole for inner key (upper section) of FIG. 7F

FIG. 7J is a plane fig. of another example of FIG. 7F

FIG. 7K is a plane fig. of another example of FIG. 7F

FIG. 7L is a plane fig. of another example of FIG. 7F

FIG. 7M is a plane fig. of another example of FIG. 7F

FIG. 7N is a plane fig. of another example of FIG. 7F

FIG. 7O is a plane fig. of another example of FIG. 7F

FIG. 7P is a plane fig. of another example of FIG. 7F

FIG. 8A is an illustrative fig. of a deadlock inner key inserted into the keyhole of this invention

FIG. 8B is a three-dimensional fig. of another example of FIG. 8A

FIG. 8C is a three-dimensional fig. of inner keys inserted into the bottom of the plug

FIG. 8D is a plane fig. of numerous inner keys of deadlock

FIG. 8E is a plane fig. of another example of FIG. 8D

FIG. 8F is a plane fig. of another example of FIG. 8D

FIG. 9A is a front view of a flat key of this invention

FIG. 9B is a front view of another key type of this invention

FIG. 9C is a side view of FIG. 9B

FIG. 9D is a front view of another key type of this invention

FIG. 9E is a front view of the engraved key of this invention

FIG. 9F is a front view of another key type of this invention

FIG. 9G is a front view of another example of FIG. 9E

FIG. 9H is a front view of another example of FIG. 9E

FIG. 9I is a front view of embossed key of this invention

FIG. 9J is a front view of engrave/embossed key of this invention

FIG. 10A is a plane fig. of an example of lock plates which are used in this invention

FIG. 10B is a plane fig. of another example of FIG. 10A

FIG. 10C is a plane fig. of another example of FIG. 10A

FIG. 10D is a front view of a plate pin

FIG. 10E is a front view of another example of plate pins in FIG. 10D

FIG. 10F is a front view of another example of plate pins in FIG. 10D

FIG. 10G is a side view of another example of FIG. 10A

FIG. 10H is a side view of another example of FIG. 10A

FIG. 11A is an illustrative fig. of a lever which is used in this invention

FIG. 11B is an illustrative fig. of another example of FIG. 11A

FIG. 11C is an illustrative fig. of another example of FIG. 11A

FIG. 12A is an illustrative fig. of an inner key inserted into a keyhole of this invention

FIG. 12B is an illustrative fig. of an inner key inserted into the bottom of the plug of this invention

FIG. 13A is a three-dimensional fig. of an embossed key of this invention

FIG. 13B is a side cross-section fig. of another example of FIG. 13A

FIG. 13C is a three-dimensional fig. of another example of FIG. 13A

FIG. 13D is a front view of plate pins before being separated into upper and lower plate pins

FIG. 13E is a plane fig. of separated plate pins and illustrative Fig. of holes

FIG. 13F is an illustrative fig. of another example of FIG. 13E

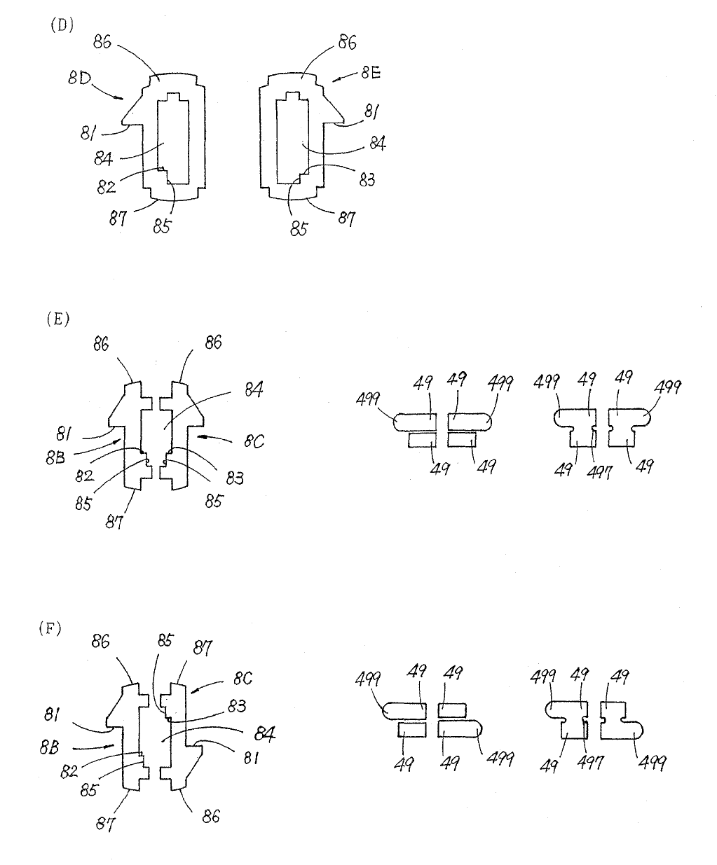

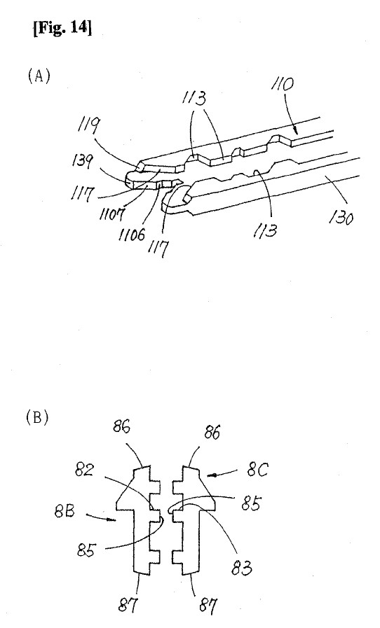

FIG. 14A is a three-dimensional fig. of an engraved key of this invention

FIG. 14B is a plane fig. of separated plate pins used for engraved keys

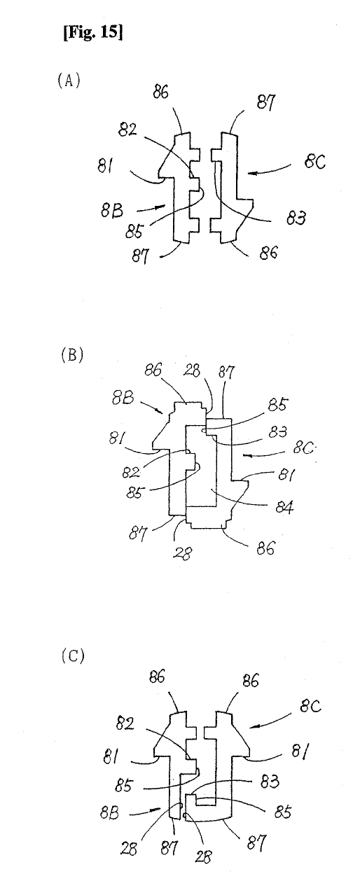

FIG. 15A is a plane fig. of separated plate pins for engraved/embossed keys of this invention

FIG. 15B is a plane fig. of another example of FIG. 15A

FIG. 15C is a plane fig. of another example of FIG. 15A

### DESCRIPTION OF NUMBERS IN FIG.

100: key

103, 113, 123, 1103: upper surfaces of waving curve or grooves

104, 1104: geometrical protrusion or grooves

106, 116, 126, 1106: flat surfaces

107, 108, 117, 118, 127, 128, 1107: inclining surfaces

109, 119, 129, 139: front surfaces (head)

130: center plate of keys

210, 220, etc: inner keys

211, 221, etc: upper sections

212, 222, etc: lower sections (lower protrusion)

214, 224, etc: top surfaces

219, 229, etc: upper surfaces of waving curve or grooves

3: cylinder

33: nut

38: groove at inner cylinder

39: interval of grooves

330, 340: upper and lower horizontal groove or holes

333: engraved groove

4: plug

40: hole for upper section of inner key

42: keyhole

45: protruded shapes

47, 32: upper and lower pin holes

49, 411: plate pin holes

410: lock plate insertion hole

417, 427, etc: spring insertion holes

418, 428, etc: pin holes

422: extended keyhole

440: staircase surface or inclining surface

441: twisted gear or twisted shapes

442: screw bolt

499: small spring hole

7, 77, 707, 717, 737, 787: springs

700: lock plate

735: protrusion at bottom side

740: center hole of lock plate

775: inner key insertion plate or spring stopper plate

8A, 8D, 8E: plate pins

8B, 8C: separated plate pins

84: plate keyhole

85: protrusion

86, 87: upper and lower protrusions

800: lever

92, 91: upper and lower pins

### IMPLEMENTATION OF INVENTION

A detailed description of this invention, with aid of fig., is as follows:

FIG. 1 is a cross-section fig. of conventional door locks. A plug (4) is installed within a cylinder (3) in a manner that inner rotation is possible; in the center of the plug, there is a horizontal keyhole (42), and there are upper and lower pins (92, 91). Numerous pins (92, 91) pass through the cylinder (3) and plug (4). When the key (100) is inserted, the waving curve (103) of the key aligns the borderlines of abovementioned upper and lower pins to the borderlines of the cylinder and plug for rotation and unlocking.

FIG. 2 is a three-dimensional fig. of one disassembled example of the invention. FIG. 3 is a cross-section fig. of an assembled example of FIG. 2, consisting of a cylinder (3), plug (4) and a stopper/hitch (6) tightened by the axle (46). This door lock structure rotates to the right and left for unlocking when the key (100) is inserted into the plug keyhole (42), thus aligning numerous plate pins (8A) of plate pin holes (49) to the horizontal grooves or holes (330, 340) of the cylinder. Additionally in the plug, there is a gear or twisted protrusion (45) with an axle (46) in one piece. The cylinder has an engraved groove (333) which is to be interlocked to the twisted protrusion; here the twisted gear or twisted shape (441) is interlocked to the engraved groove. A spring (7) can be added to the axle (46) so as to push or pull the plug. There is also a stopper/hitch (6) which is fixed at a location where the twisted protrusion is pulled but of the engraved groove. When the key is inserted to this structure, many plate pins (8A) are aligned, rotating and pulling the key to unravel the gear from the engraved groove for locking and unlocking through left or right rotation. When coercive rotation is attempted, the plug is separated at the torque share section (490) in between the gear and lower section of the plug; the gear, which is pulled by a spring, does not pull out. Also, when a high-intensity pin is innate in this structure, destruction is difficult even with a drill. This configuration is most adequate for car door locks.

FIG. 4A is another three-dimensional fig. of one disassembled example of the invention. FIG. 4B is a partial cross-section fig. of FIG. 4A; FIG. 4C is an assembled plane fig. of FIG. 4B, FIG. 4D is a rotated cross-section fig. of FIG. 4C. FIG. 4D is same as Configuration 2, but plate pins (FIG. 10A, 10G) are not indicated.

FIG. 5A is a three-dimensional fig. of one disassembled example of the invention. The protruded shape (45) is a screw bolt and there is a nut (33) to which the screw bolt (442) is interlocked. FIG. 5B is an assembled cross-section fig. of FIG. 5A. When the bolt is at the center of the nut, locking or unlocking occurs when the protrusion of plug is adjacent to the bottom of the cylinder. When the key is rotated, locking or unlocking is possible; when the key is pulled vertically, the key pulls out and the plug cannot be turned. FIG. 5C is a cross-section fig. of an absorption axle; the axle (46) is to be locked when the plug moves vertically (FIG. 3, 4, 5) and a flange (51) and absorption axle (50) with an angled hole (52) is inserted into the bottom of the plug. This is locked along with the axle (8) by the stopper/hitch (6); when the angled axel (46) is inserted and installed to the angled hole (52), the axle can only be rotated to right and left. Such structures shown in FIGS. 4 and 5 are adequate for deadlocks and digital door locks.

FIG. 6A is another three-dimensional fig. of one disassembled example of the invention. The plug (4) has a lock plate (700, 710, 720, 740; FIG. 10A) runs through the side hole (410) of the plug to pass all the way through to the upper pin hole (47). In this cylinder (3) and plug (4) which has a stopper/groove (414) at the upper section (41), there is a hole (314) which corresponds to the stopper/groove (414), upper hole (310) and a protrusion (316) at the lower side of the cylinder. There also is a lever (800) which has an upper section (810), center section (830) and a lower section (820) with pin holes (850); a pin (10) with an upper section (11), a lower section (12) and a stopper ring (13); and a spring (787). FIG. 6B is an assembled cross-section fig. of FIG. 6A; plate pins (700) pass through the hole (410) in the plug (4), and the upper section (710) is inserted into the upper pin hole (47) of the plug. The upper section (810) of the lever runs through the cylinder hole (314), inserted into the stopper/groove (414) and the lower section (12) of the pin is inserted into the upper hole (310). This structure itself is inserted into the plug and while the center section (830) of the lever is being pressed, the upper section (11) is installed to the pin hole (850) at the lower section of the lever, along with a spring (787). When the key is inserted the incline (108) and the front surface (109) of the key are inserted into the center hole (740) of the lock plate, thus pushing the lock plate upwards so that the lower section of the (720) lock plate is pulled out of the cylinder lower hole (320). This makes the lower section of the lock plate aligned to the outer border surface of the plug and pulls the upper section (810) of the lever out of the stopper/groove (414), allowing the key to turn and unlock the structure.

FIG. 7A is an illustrative fig. of inner keys inserted into keyholes of this invention. FIG. 7B is a front view of another example of FIG. 7A. FIG. 7C is a front view of another example of FIG. 7B, and FIG. 7D is an illustrative fig. of multiple inner keys inserted into keyholes of this invention. FIG. 7E is an illustrative fig. of an inner key inserted into an extended keyhole of FIG. 7D. FIG. 7F is an illustrative fig. of inner keys inserted into the bottom of the plug. FIG. 7G is an illustrative fig. of inner keys in another example of FIG. 7F; FIG. 7H is an illustrative fig. of inner keys in another example of FIG. 7F. FIG. 7I is an illustrative fig. of the hole for inner key (upper section) of FIG. 7F and FIG. 7J is a plane fig. of another example of FIG. 7F. This is identical to descriptions of Configuration 7. FIG. 7K is a plane fig. of another example of FIG. 7F; FIG. 7L is a plane fig. of another example of FIG. 7F; FIG. 7M is a plane fig. of another example of FIG. 7F; FIG. 7N is a plane fig. of another example of FIG. 7F; FIG. 70 is a plane fig. of another example of FIG. 7F; FIG. 7P is a plane fig. of another example of FIG. 7F. As shown in FIG. 7I, plate pin key holes (FIG. 10D, 10E, 10F) and separated plate pins (FIG. 13E) is best to be within range of the central key hole, so that they will correspond to the geometrical shapes of front surfaces (109, 119, 129, 139) and inclines (107, 108, 117, 118, 127, 128) of a car key (FIG. 9).

FIG. 8A is an illustrative fig. of a deadlock inner key inserted into the keyhole of this invention. FIG. 8B is a three-dimensional fig. of another example of FIG. 8A; this is a deadlock inner key which has one inner key inserted into the keyhole (FIG. 12A). FIG. 8C is a three-dimensional fig. of inner keys inserted into the bottom of the plug; this structure has a upper section insertion hole for upper section of inner key (40) and the lower section of the inner key is a protrusion (212, 222, etc) which is larger than the upper section (211, 221, etc), thus allowing enough space for the spring (707). This is advantageous because protrusions (2) can be selectively adjusted on the protrusion holes (200) at the top. This structure best fits deadlock structures. FIG. 8D is a plane fig. of numerous inner keys of deadlock; FIG. 8E is a plane fig. of another example of FIG. 8D; FIG. 8F is a plane fig. of another example of FIG. 8D. The inner key of FIGS. 7F and 7H are located to correspond to the position of inclines (108) and grooves (104) of the key (FIG. 9B, 9C).

FIG. 9A is a front view of a flat key of this invention; a flat surface (106) is formed on the incline so that the lock plates of FIG. 10A or plate pins of FIG. 10D become aligned to the central plate keyhole (84). This is identical to descriptions of Configurations 1 and 5. FIG. 9B is a front view of another key type of this invention, and FIG. 9C is a side view of FIG. 9B. Description of this Fig. is same as FIGS. 8D, 8E and 8F. FIG. 9D is a front view of another key type of this invention; one or more geometrical protrusion or groove is formed on the upper section of a flat key to press the top side of the inner key shown in FIGS. 12A and 12B. FIG. 9E is a front view of the engraved key of this invention, and this is an engraved key which has geometrical protrusions or grooves (1104) in the front surface (139). FIG. 9F is a front view of another key type of this invention, and the descriptions are same as that of FIG. 9A. FIG. 9G is a front view of another example of FIG. 9E; a flat surface (116) is formed on the incline (117), using lock plates of FIG. 10C as plate pins (not grooves of flat surfaces). This key type is utilized as an engraved key in Configuration 5. FIG. 9H is a front view of another example of FIG. 9E; an engraved key and plate pins of FIG. 10E are used together. Unlike FIG. 10G, this structure can reduce probability of equal keys since one or more waving curves or grooves (1103) and one or more plate pins (8A) at the center plate (130). FIG. 9I is a front view of embossed key of invention. Geometrical grooves (1104) can be made at the front surface (139) of waving curves and waving curve or grooves (113, 123) at the incline (118, 128). This key also has plate pins and can be utilized for Configuration 5. FIG. 9J is a front view of engrave/embossed key of this invention; this is a combination of FIGS. 9G and 9I.

FIG. 10A is a plane fig. of an example of lock plates which are used in this invention. A hitch (780, 790) is formed on the upper section (710), lower section (720), center hole (740) and each side of the upper section. The length of the upper section and the lower section are either as long as or shorter than the plug. Movement is possible in the center hole (740) due to the incline (216) of the inner key. The upper section can be made shorter than the lower section (720); the length can be as short as a pin (10) so that it can be interlocked to the plug. FIG. 10B is a plane fig. of another example of FIG. 10A; the center hole is circular so that the upper section of the key and bullet-shaped inclines can be inserted. FIG. 10C is a plane fig. of another example of FIG. 10A; protrusions (745) are pushed or pulled by the incline (107) of the key to move the lock plates front or backwards. FIG. 10D is a front view of a plate pin; FIG. 10E is a front view of another example of plate pins in FIG. 10D; FIG. 10F is a front view of another example of plate pins in FIG. 10D; flat keys, engraved keys and embossed keys are utilized (FIG. 9A, 9F, 9H, 9I). FIG. 10G is a side view of another example of FIG. 10A; FIG. 10H is a side view of another example of FIG. 10A; the protrusion at bottom side (735) is identical to that in Configuration 2 and the axle (730) is pressed by the spring (717) to interlock the lower section (720) to the groove (320) of the cylinder. When this is formed at the lower part of the upper section, the upper section (710) is inserted into the cylinder hole.

FIG. 11A is an illustrative fig. of a lever which is used in this invention; in the lever (800), which consists of an upper section (810), lower section (820), center section (830), the upper section has a [symbol] shape and there are pin holes (850) at the lower section. FIG. 11B is an illustrative fig. of another example of FIG. 11A, and FIG. 11C is an illustrative fig. of another example of FIG. 11A. Descriptions are same as those in Configuration 8.

FIG. 12A is an illustrative fig. of an inner key inserted into a keyhole of this invention. Although there is only one inner key (210; FIG. 7A), there can be more than one as described in Configuration 7 (FIG. 7D). IN the case of car door locks, an extended keyhole (422) is made, just as described in FIG. 7I, 7K, 7L, 7M, 7N, 7O, 7P. In case of deadlocks, FIGS. 8A and 8B are used for one inner key and the inner key of 7D can be installed into FIGS. 8D and 8E when there are more than one inner key. FIG. 12B is an illustrative fig. of an inner key inserted into the bottom of the plug of this invention; for car door locks, inner keys of FIGS. 7F and 7G are installed to the bottom of the plug (separated from the keyhole) as shown in FIGS. 7K, 7L, 7M, 7N, 7O, and 7P. For deadlocks, inner keys (FIGS. 7F and 7H) are installed as shown in FIGS. 8D, 8E and 8F.

FIG. 13A is a three-dimensional fig. of an embossed key of this invention, and FIG. 13B is a side cross-section fig. of another example of FIG. 13A. The key (100) has a front surface (119, 129), incline (118, 128), waving curve or groove (113, 123) and an embossed key at the upper section. FIG. 13C is a three-dimensional fig. of another example of FIG. 13A; this is an embossed key without the center plate (130) of the key. Descriptions of this key are same as those of 13A and 13B. FIG. 13D is a front view of plate pins before being separated into upper and lower plate pins. A plate pin (8D) has stoppers (82) and another plate pin (8E) has a stopper (83) at a symmetrical position from the first plate pin (8D). FIG. 13E is a plane fig. of separated plate pins and illustrative Fig. of holes; it shows separated (upper and lower) plate pins (8B, 8C) which have stoppers 81 and 82/83, respectively. However, plate pins should be separated to upper and lower holes (49) and the spring holes (499) should be symmetrical. This pair is to be called separated plate pins (8B, 8C) and another set of separated plate pins (8C, 8B) can be inserted from the top, bottom or each side. FIG. 13F is an illustrative fig. of another example of FIG. 13E; it is different from FIG. 13E only in that the separated plate pins (8B, 8C) can be inserted from any side and in two pairs.

FIG. 14A is a three-dimensional fig. of an engraved key of this invention. The key (100) has an engraved waving curve or groove (113, 123) at the center plate. At each top and bottom side of the front surface (139), inclines (117, 127) are to be carved towards the central groove. This invention can have one or more geometrical protrusions (1104) at the front surface (139) and also can be engraved in a symmetrical method at the inclines (1107) to form an ‘M’ shape (FIG. 9H). Also, the engraved key can have geometrical protrusions (1104) like shown in FIG. 9G. FIG. 14B is a plane fig. of separated plate pins used for engraved keys. Separate pin holes at the plug are same as those of FIG. 13E.

FIG. 15A is a plane fig. of separated plate pins for engraved/embossed keys of this invention. The engraved/embossed key is as describe in FIG. 9J, and FIG. 15A shows separated plate pins used for this key type. FIG. 15B is a plane fig. of another example of FIG. 15A; FIG. 15C is a plane fig, of another example of FIG. 15A. Separated plate pins of FIG. 15B are engraved separated plate pins that have vertical carved surfaces (28) which are aligned to the protrusion (85) at the center of the keyhole. Plate pins 8C are embossed separated plate pins that have a vertical carved surface (28) adjacent to the other plate pins 8B. The vertical carved surface (28) of plate pins 8B is inserted adjacently to the existing separated plate pins 8C which is pressed and held at the spring stopper (81) due to a spring (9). Here, an interval can be made between the carved surfaces of each separated plate pins so that this interval can be interlocked to each groove in the cylinder. When the engraved/embossed key is inserted into the plate keyhole (84) of these separated plate pins (8B, 8C) the engraved section and protrusions of the embossed section presses the stopper (83), depending on the height of protrusions so that each protrusion (86) are pulled out of the cylinder groove or hole (330), thus making an alignment with the outer border surface of the plug and enabling unlock. Also, such separated plate pins can be made into two pairs (8B, 8C, 8C, 8B). FIG. 15C refers to a state where embossed separated plate pins (8C) are inserted from upper and lower sides. The separated plate pins can be inserted in separate and independent holes or even in symmetrically opposite positions.

### INDUSTRIAL APPLICABILITY

Door locks are being utilized in various industrial areas. Such door locks, of course, should not be opened or damaged easily by anyone.

This invention has a device for preventing coercive rotation and its structure allows minimization of equal key probabilities. This invention is for utilization in simple structures such as cylinder-type door handle locks, lever-type door handle locks, analog keys of digital door locks, and also for utilization on emergency analog keys for car door locks with no-key structures; analog keys are essential as emergency keys for digital door locks as they show fragility on static electricity, magnetic fields, surges, and heat in case of fire.

1. In the case of ordinary door locks with a cylinder (3), a rotating plug (4) installed inside the cylinder with a keyhole (42), an axle (46) formed on the bottom side, and numerous pins (91, 92) passing through the cylinder (3) and plug (4); when the key (100) is inserted, abovementioned upper and lower pins (92, 91) are aligned to the surface of the plug (4) to allow rotation of plug (4) and axle for locking and unlocking, door locks characterized by the following: One or more lock plate holes (410) are made on the lower side of the plug (4), with the keyhole extended into a single space with each lock plate hole; the cylinder (3) has a number of holes (32) corresponding to the number of lower pins (91) and lock plate holes (320) corresponding to the number of lower section (720) of the lock plate (700) at the side; the lock plate (700) has hitches (780, 790) and a center hole (740) which is to have the inclines (108) of the key inserted; here the key is either a flat key with a front surface (109) and incline (108), and also a bullet-shaped key or a key with flat surfaces (106) in between inclines (108); in terms of assembly, lock plates are inserted into the lock plate holes (410) and the cylinder (3) and plug (4) are combined with lower pins (91) and springs (9) inserted into cylinder pin holes (32); here the lower section (720) is interlocked to the hitch, and when the key is not inserted, the lower pins (91) press the lock plates so that the lower section of the lock plates are hitched into the holes (320) of the cylinder; the key is to be Inserted or pushed vertically so that the lock plates can be pushed upwards to allow rotation in order to lock/unlock the structure.

2. From claim 1, door locks characterized by the following: Lock plates (700) and lock plate insertion holes (410) are rid of but instead an upper pin hole (47) is on the plug so that upper and lower pins (92, 91) and springs (9) are pressed at a position where the lower pin hole (32) of the cylinder and upper pin hole (47) of the plug are matched.

3. From claim 1, door locks characterized by the following: There are lock plates (700) with protrusions at bottom side (735) of the upper section; at this bottom side of the lock plate, a protrusion (45) shaped like a staircase (440) is made onto the lock plate; at the inner lower section of the cylinder, there is a groove (38) with an interval (39) for the staircase (440) surface; to this, a spring (7) can be inserted on the location where the plug is pulled out of the groove (38) after rotation and puffing, to push or pull the plug or to fix the stopper/hitch (6) in position; when the key is inserted, the front section of the lock plate rises, thus unraveling the protrusion at bottom side (735), and this makes the staircase surface hitch onto the groove, and rotation is only allowed to the extent of the interval made in the structure; this staircase surface is locked onto the hitch (31) and when the key is pulled out vertically, the protrusion at bottom side (735) is interlocked with the interval, thus disabling any rotation of the plug.

4. From claim 3, door locks characterized by the following: The lock plate does not have protrusion at bottom side (735) and the staircase-shaped (440) protrusions are modified into geometrical shapes of twisted forms of rectangles, squares, pentagons and ellipses; a groove (38) with a hitch is to be interlocked with a twisted engraved groove (333).

5. From claim 4, door locks characterized by the following: The twisted & protruded shape (45) is changed into a screw bolt (442), and a screw can be added onto the top of the plug in need; the twisted groove of the cylinder is changed into a nut (33) that is to be interlocked with the screw; this nut can be added onto the inner top side of the plug.

6. From claim 4 door locks characterized by the following: Lock plates are rid of, and there also is a key (100) that is either an inclined (108) key or a flat key.

7. From claim 5, door locks characterized by the following: The nut (33) remains but with mobility so that forward/backward movement locks or unlocks the structure; the key can be pulled out when pulled vertically from an inserted and non-rotated state.

8. From claim 7, door locks characterized by the following: Lock plates (700) are rid of and the key (100) is either an inclined (108) key or a flat key.

9. In the case of ordinary door locks with a cylinder (3), a rotating plug (4) installed inside the cylinder with a keyhole (42), an axle (46) formed on the bottom side, and numerous pins (91, 92) passing through the cylinder (3) and plug (4); when the key (100) is inserted, abovementioned upper and lower pins (92, 91) are aligned to the surface of the plug (4) to allow rotation of plug (4) and axle for locking and unlocking, door locks characterized by the following: There are extended inner keys holes (422) for one or more inner keys to be separately inserted into; the plug (4) has pin holes (418, 428, etc), upper pin holes (47) and spring holes (417, 427, etc); as for inner keys, they have geometrical top surfaces (214, 224, etc), upper sections (211, 221) and also horizontal grooves (218, 228, etc) at the sides along with waving curves or grooves (219, 229, etc) beneath these horizontal grooves, and lower sections (212, 222, etc) beneath these waving curves or grooves; as for the cylinder (3), it has lower pin holes (32) located in correspondence with the upper pin hole (47) of the plug; there are one more inner keys (210, 220, etc) to be inserted separated into extended keyholes (422); the plug has this extended keyhole (422) and springs (707) inserted in spring insertion holes (417, 427, etc) and pins (1) passing through pin holes (417, 427, etc) and into each horizontal grooves (418, 428, etc) of the inner keys; then, the plug (4) is installed into the cylinder (3) and assembled by pressing them together with upper and lower pins (92, 91) and small springs (9); and, the key is inserted to press the inner key with the front surface (head) or inclining surfaces (108) of the key or even with geometrical grooves (104) in between each inclining surface; when the inner key is pressed, upper and lower pins are aligned to enable rotation or pressurization for unlocking the structure.

10. From claim 9, door locks characterized by the following: The axle (46), which is a single attached piece with the plug (4), is separated so as to form a plug and axle (20; 46); an axle hole (48) is made at the bottom of the plug (44); here, this axle hole is a single space with the extended keyhole (422) for inner keys; horizontal stoppers/grooves (218, 228, etc) at the upper section of the inner keys are rid of, but instead there can be protruded lower sections (212, 222, etc) in need; these lower sections (212, 222, etc) are inserted into each inner key insertion hole (40; 422) with a spring (707) inserted to each lower section and held together in single layer by a spring stopper plate (775); then the axle is inserted and fixed into the axle hole (48) to form the plug.

11. From claim 10, door locks characterized by the following: The plug (4) has holes for upper section of the inner key (40: 422) at geometrical protrusion locations (104) in between inclining surfaces (108); here, the upper section of the inner key (210, 220, 230, 240) is in a r shape so that there is an angle between the inner key and upper pin holes (47) of the plug.

12. From claims 10, door locks with the following structure: The upper section holes of the plug are separately located and upper pin holes (47) are made in correspondence to the number and location of grooves (219, 229, 239, 249) beneath the plug at the side; in the cylinder (3), lower pin holes (32) are made and they correspond to the number and location of upper pin holes on the plug; here, the spring stopper plate (775) has holes corresponding to the number and location of additional upper section insertion holes (40); also, the inner key has a [symbol] shape, and a multiple-layer plug is installed into the cylinder (3).

13. In the case of ordinary door locks where there is a cylinder (3), plug (4), axle (46) and a stopper/hitch (6) and where the key (100) is inserted into this structure to align numerous plate pins (8A) at horizontal grooves or holes (330, 340) of the cylinder to enable rotation and unlocking of the structure, door locks characterized by the following; Twisted gear or twisted protrusion (45) shapes are made in the upper section (41) or lower section of the plug; on the inner upper/lower section of the cylinder (3) there are engraved grooves (333) to be interlocked with abovementioned twisted gears of twisted protrusion shapes; a spring (7) can be added to push or pull the plug; and this door lock configuration has a stopper/hitch (6) at the location where the twist protrusion is unraveled from the engraved grooves.

14. In the case of ordinary door locks where there is a cylinder (3), plug (4), axle (46) and a stopper/hitch (6) and where the key (100) is inserted into this structure to align numerous plate pins (8A) or pairs of separated plate pins (8B, 8C) at horizontal grooves or holes (330, 340) of the cylinder to enable rotation and unlocking of the structure, door locks characterized by the following: One or two plate pins pass through the lower section of the plug; a small spring hole (499) is made, which is at a single space as the keyhole; the cylinder extends from horizontal grooves or holes (330, 340) which are to have plate pins inserted into them; here the key (100) is an M-type key which has waving curves or grooves in the rather thick center plate (130), meaning that grooves are made on a flat surface before the engraving; however, as an M-typed key, there are one or more inclines (1107, 1106, 1107) and flat surfaces (1106) waving down symmetrically to the center in an engraved form; in terms of plate pins (8A) a pressurization point of the plate pins are made in need, perhaps in symmetrical positions; plate keyholes (84) into which the M-type key is inserted into is separated into upper and lower keyholes; it has a size that allows the key to pass when inclines (1107) and flat surfaces (1106) press the inner structure; bottom of the upper plate keyhole (84) is made into protrusions (85) and plate pins with spring stoppers (81) on one or both sides; then these plate pins (8A) are inserted into the plate pin holes (49) along with the small spring (9), pressed by the spring stopper (81); when the key is inserted into the center plate keyholes (84), the protrusion (85) is pressed by the incline (1107) to pull the upper protrusion (86) out of the groove or hole (330) and aligning the plug surface with plate pin surfaces at the flat surface (1106) of the key, thus enabling rotation and unlocking of the structure.

15. From claim 14, door locks characterized by the following: The key (100) is an embossed key which has symmetrical inclines (108) and flat surfaces which widen from the front surface (109) and in, with conventional waving curves or grooves added also; as for the plate keyhole (84), it is large enough to allow insertion of inclines and flat surfaces, and the lower section of the keyhole is a protrusion (85), so that when the key is inserted, inclines (108) will press the protrusions and thus pulling the upper protrusions (86) down to make alignment at the flat surface level (106); the key is enabled for rotation and unlocking the structure.

16. From claims 14, door locks characterized by the following: Stoppers/groove (414) and a hole (314) are made onto the upper section of the plug, protruded shapes (45), or the axle (46); pin holes (32) are made to allow interlocking of the lower section (12) of the pin (10) into grooves (340), which is at the same position as the stopper/groove (414) of the plug; as for the cylinder, when there is a stopper at the upper section (41) of the plug, a protrusion (316) with pin holes (315) are made, and when there is a stopper at protrusions or axes, a protrusion (316) is made in between pin holes (32) and the upper of the plug; to this, a lever (800) with a n shaped upper section (810), center section (830) and lower section (820) with pin holes (850), and pins (10) with stopper rings (13) and upper and lower sections (11, 12), and also a spring (787) is assembled onto the cylinder; the lower section of the pin (10) with upper section (11), lower section (12), and stopper ring (13) is inserted into the pin hole (32) so as to meet the lower protrusion (87) of plate pins; here, the upper section (810) of the lever is inserted into the hole (314) and stopper/groove (414) and while the center section (830) of the lever presses the upper section (11) of the pin, the lower section of the lever (820) is assembled into the pin hole (315) with a spring (787); then, when the key is inserted, upper protrusions (86) the plate pins are pulled out of the upper horizontal grooves or holes (330) due to inclines (1107, 108) of the keys so as to make alignment of lower section of the pin and inner border surface of the cylinder so that the lever is pulled out of the stopper/groove (414) and the key can be rotated for unlocking.

17. From claims 14, door locks characterized by the following: A twisted gear (441) or twisted protrusion shape is made on the upper section (41) or lower section of the plug; there is also an axle (46); as for the cylinder (3), it has an engraved groove (333) to be interlocked with the twisted gear or twisted protrusion shapes; to this, a spring (7) can be added to the axle (46) to push or pull the plug; another specification is that there is a stopper/hitch (6) at the location where the twisted protrusion is unraveled.

18. From claim 16, door locks characterized by the following: A twisted gear (441) or twisted protrusion shape is made on the upper section (41) or lower section of the plug; there is also an axle (46); as for the cylinder (3), it has an engraved groove (333) to be interlocked with the twisted gear or twisted protrusion shapes; to this, a spring (7) can be added to the axle (46) to push or pull the plug; another specification is that there is a stopper/hitch (6) at the location where the twisted protrusion is unraveled.

19. In the case of ordinary door locks where there is a cylinder (3), plug (4), axle (46) and a stopper/hitch (6) and where the key (100) is Inserted into this structure to align numerous plate pins (8A) or pairs of separated plate pins (8B, 8C) at horizontal grooves or holes (330, 340) of the cylinder to enable rotation and unlocking of the structure, door locks characterized by the following: There are extended inner keys holes (422) for one or more inner keys to be separately inserted into; the plug has pin holes (418, 428, etc), plate pin holes (411) or paired holes (49) for separated plate pins (8B, 8C), small spring holes (499) and spring holes (417, 427, etc); as for inner keys, they have geometrical top surfaces (214, 224, etc), upper sections (211, 221) and also horizontal grooves (218, 228, etc) at the sides along with waving curves or grooves (219, 229, etc) beneath these horizontal grooves, and lower sections (212, 222, etc) beneath these waving curves or grooves; as for the cylinder (3), there are horizontal grooves or holes (330, 340) to allow insertion of upper and lower protrusions (86, 87) of plate pins (8A) or pairs of separated plate pins (8B, 8C), and they are extended to the conventional horizontal grooves or the hole; and the plate pins or separated plate pins, along with small springs (9), springs (707), pins (1) and keys (100), are inserted into the plug with small springs and the lower section (212, 222, etc) of the inner keys are separately inserted into the extended keyhole (42); thus, each plate pin (8A) or separated plate pins (8B, 8C) pass through the plate keyhole (84), springs (707) are inserted into the spring holes (417, 427, etc) and pins (1) are inserted into holes (218, 228, etc); then the plug assembled from the abovementioned components is installed in the cylinder; and when the key is inserted, front surfaces (109, 119, 129, 139), inclined surfaces (107, 108, 117, 118, 127, 128) and their waving curves press geometrical surfaces of the inner key (214, 224, etc) to push the protrusions of the plate pins or separated plate pins (8A, 8B, 8C); this in turn pulls the upper protrusion (85) away from the groove or hole (330) to align it with the plug border surface, enabling rotation and unlocking of the structure.

20. From claim 19, door locks characterized by the following: The axle (46), which is a single attached piece with the plug (4), is separated so as to form a plug and axle (20; 46); an axle hole (48) is made at the bottom of the plug (44); here, this axle hole is a single space with the extended keyhole (422) for inner keys; horizontal stoppers/grooves (218, 228, etc) at the upper section of the inner keys are rid of, but instead there can be protruded lower sections (212, 222, etc) in need; these lower sections (212, 222, etc) are inserted into each inner key insertion hole (40; 422) with a spring (707) inserted to each lower section and held together in single layer by a spring stopper plate (775); then the axle is inserted and fixed into the axle hole (48) to form the plug.

21. From claim 20, door locks characterized by the following: The plug has selectively chosen angled or geometrical shapes at the upper section, geometrical grooves (1104), or waving curves or grooves (103, 113, 123); as for the inner key (210, 220, 230, 240), the upper section of the Inner key is at the same location and shape as the hole for upper sections of inner keys (40).

22. From claims 20, door locks characterized by the following: There are multiple inner keys (210, 220, . . . , 290, etc) and the plug has holes for upper sections of inner keys (40) at the exact same location, number and shape as the inner keys, and there are also plate pin holes to be pressed by waving curves or grooves of each inner key; a single layer of abovementioned separated plate pins are held together with a spring stopper plate (775), and other inner keys pass through holes in the spring stopper all the way into the upper section hole of the plug; then, the plug is pressed and held together in multiple layers, and then the axle (46) is fixed into the axle hole (48).

23. In the case of ordinary door locks where there are numerous separated plate pin (8B, 8C) holes (49) and small spring holes (499) on each side of the plug (4), and separated plate pins are separated in pairs at a constant interval, and the plug also has many of these separated plate pin Insertion holes in between separated plate pin holes at the bottom and it is at a single space with the extended keyhole; inside the plug insertion hole, the cylinder (3) has pairs of horizontal grooves of holes (330, 340) into which the upper/lower protrusions (86, 87) of separated plate pins are inserted; separated plate pins (8B, 8C) have upper protrusions (86), spring stoppers (81) beneath it and under the stoppers lower protrusions (87) and the center keyhole (84), cut into upper and lower sections, and they have protrusions that have stoppers (82, 83) in pairs at the center; and where the key (100) is an engraved key which begins with a vertical surface at the upper section and inclining surfaces (117, 127) all the way into the center plate, door locks characterized by the following: the embossed key (100) has inclines (118, 128), waving curves or grooves (113, 123) at four points on the front and back (110, 120), and these inclines and grooves are embossed in this case; also, the upper section (119, 129) and the upper section (139) are in a vertical position, and separated plate pins (8B, 8C) have protrusions (85) as stoppers (82, 83) on upper surface of lower protrusions (87).

24. From claim 23, door locks characterized by the following: The center plate (130) of the key does not exist.

25. From claim 23, door locks characterized by the following: The key (100) is an embossed key on the upper side of the front and bottom side of the back, but engraved on the bottom side of the front and the upper side of the front; separated plate pin 8B is engraved and separated plate pin 8C is embossed; 8B is inserted from the top and 8C is inserted from the bottom.

26. From claims 23, door locks characterized by the following: One or more geometrical protrusions or grooves (1104) are made on the front surfaces (119, 129, 139) and the front surface (139); the key has one or more flat surfaces (116, 126) at or grooves (113) at inclines (117, 127, 118, 128); in this structure, the geometrical shapes (214, 224, etc) of inner keys (210, 220, etc) are pressed with all or parts of the front surfaces.

27. From claim 26, door locks characterized by the following: There are engraved keys for the upper side of the front and lower side of the back, meaning that there are engraved keys on four points.

28. From claim 27, door locks characterized by the following: Geometrical protrusions or grooves (1104) are rid of from the front surface (139) and the key is an M-type key which has an incline (1107) that narrows down into the center plate of the key; one or more waving curves or grooves (1103) or flat surfaces (1106) are carved symmetrically from the centerline.

29. From claim 28, door locks characterized by the following: Flat surfaces (116), waving curves or grooves (113) do not exist.
